(19) United States
(12) Patent Application Publication
(10) Pub. No.: US 2001/0031660 A1
(43) Pub. Date: Oct. 18, 2001

(54) Method and apparatus for playing a game of chance over a computer network

(76) Inventors: Randolph James Wilk, Toronto (CA); Craig Clifford Armstrong, Toronto (CA)

Correspondence Address: Mark B. Eisen, Dimock Stratton Clarizio, 20 Queen Street West, Suite 3202, Box 102, Toronto, ON, M5H 3R3, CA

(21) Appl. No.: 09/854,683

(22) Filed: May 15, 2001

Related U.S. Application Data
(63) Continuation of application No. 09/032,046, filed on Feb. 27, 1998, now abandoned.

(30) Foreign Application Priority Data
Feb. 23, 1998 (CA) 2.230.184

(51) Int. Cl. A63F 9/24; A63F 13/00; G06F 17/00; G06F 19/00

(52) U.S. Cl. 463/19; 463/42

(57) ABSTRACT

A method an apparatus for playing a game of chance such as “bingo” over a computer network provides a central system including a computer comprising a database, host system software, communications means, and a random number generator for generating numbers in a random sequence, a plurality of remote stations for creating and distributing sheets of card strips of one or more game cards, located at a plurality of locations remote from the central system. Each of the remote stations comprises a random number generator for creating a matrix of numbers for each game card on a game card strip and means for communicating the matrix or matrices of numbers to the central system for storage in the database. The central system includes means for assigning a card strip identifier to each card strip and for communicating the card strip identifier to the remote station associated with each card strip. The card strips are printed on one or more printers in communication with each remote station.

### CROSS-REFERENCE TO RELATED APPLICATION

This application is a continuation of application Ser. No. 09/032,046, filed Feb. 27,1998.

### FIELD OF THE INVENTION

This invention relates to games of chance. In particular, this invention relates to a system and method of playing a game of chance such as “bingo” over a computer network.

### BACKGROUND OF THE INVENTION

The game known as “bingo” is a popular game of chance. Bingo involves a game card bearing numbers, usually ranging from 1 to 75 in a 5×5 matrix with a group of five numbers from the series 1 to 15 under the heading “B”; a group of five numbers from the series 16 to 30 under the heading “I”; a group of five numbers (or four numbers plus a “free” space) from the series 31 to 45 under the heading “N”; a group of five numbers from the series 46 to 60 under the heading “G”; and a group of five numbers from the series 61 to 75 under the heading “0”. A game operator calls out numbers randomly, one at a time, usually along with the letter heading under which the number falls, and the players each mark the space (if any) in which the called number appears on their card or cards. The object of the game is to be the first to mark a designated pattern on the game card, which can typically be a line (row or column), an “X” shape (both diagonals), a cross (center row and center column), four corners, or a complete card in which case all 25 spaces (including a “free” space typically provided as the center space of the numerical matrix) must be marked in order to win. The player who completes the designated pattern and calls “bingo” first is the winner.

In order to ensure the orderly progress of a game of bingo, each number called by the game operator should arise only once, and the operator must be able to verify that a win has occurred when declared by a player. Conventionally the numbers from 1 to 75 have been marked on a plurality of game pieces such as balls, which are drawn from a drum or the like in random order and set aside after they are drawn for reference when a win must be verified. More recently, computers incorporating random number generators have been used to generate the bingo numbers during play, which are called by the operator in the order that they are generated. However, in a typical game of bingo the operator and the players are situated in the same premises, the players being within audible distance of the operator and often able to view the called numbers on a monitor as an additional means of determining which numbers have been called.

Although so-called “bingo halls” are quite popular, allowing players to play bingo in competition with others in a particular location, the excitement of playing bingo against a much wider audience, and the ability for an operator to offer larger prizes due to the greater number of participants in a widespread bingo game, are very appealing to many bingo players. Bingo halls, whose revenues are generated more or less in proportion to the attendance at the bingo hall, would also benefit from a larger scope of participation in a bingo game by the increase in the number of players who are attracted by the larger prizes. It would accordingly be advantageous to provide a system for playing bingo that can be played at remote locations distributed throughout one or more geographic locales so as to be readily accessible to the public on a widespread basis.

### SUMMARY OF THE INVENTION

The present invention addresses these and other objects by providing a system and method of playing a game of chance such as bingo over a computer network, in which remote stations for creating and printing game cards and for communicating to participants numbers which are randomly generated at a central location during the game of chance can be located in any number of locations remote from the central system.

The invention accomplishes this by providing a central system, preferably at a single location, comprising host application, database and communications functions which communicates through bidirectional communications lines to remote stations supporting suitable client software. The remote stations create card strips upon request by a remote station operator, each card strip consisting of one or more game cards.

The matrix or matrices of numbers in each card strip are communicated to the central system where they are recorded and assigned card and strip numbers, which are encrypted with strip identifier information to create a unique strip identifier. The strip identifier information (and optionally the card numbers) are communicated to the remote station where a sheet of card strips is printed by one or more printers in communication with the remote station.

During the game of chance, for example a bingo game, the central system random number generator generates a random sequence of bingo numbers from 1 to 75 and the central system communicates the numbers, one at a time, simultaneously to all remote stations where they are preferably displayed on bingo hall monitors and “called out” by voice recorded in memory at the remote station or a speech synthesizer (or if desired by the remote station operator). The players mark their cards in conventional fashion, and when a participant has completed the required pattern of numbers in a game card matrix and declares a win by calling out “bingo” an operator at the remote station sends a stop signal to the central system. The central system suspends play at all remote stations while the winning bingo card is identified and the central system matches the numbers “called” during play against the numbers on the winning game card, as stored in the central system database, to verify that a win has occurred.

The present invention thus provides a system for playing bingo over a computer network, comprising a central system including a computer comprising a database and host system software for controlling the progress of a game of bingo, communications means, and a random number generator for generating bingo numbers in a random sequence, a plurality of remote stations for creating and distributing sheets of bingo card strips each comprising at least one bingo game card, located at a plurality of locations remote from the central system and in communication with the central system, each of the remote stations comprising a random number generator for creating a matrix of numbers for each of said at least one bingo game cards to be printed on a game card strip, the remote stations including means for communicating the matrix of numbers for each game card to the central system for storage in the database, the central system including means for assigning a card strip identifier to each card strip and means for communicating the card strip identifier to the remote station associated with each card strip, and one or more printers in communication with each remote station for printing one or more game card strips.

The present invention further provides a method of playing bingo over a computer network comprising a central system including a computer comprising a database and host system software for controlling the progress of a game of bingo, communications means, and a random number generator for generating bingo numbers in a random sequence, and a plurality of remote stations for creating and distributing sheets of bingo card strips each comprising at least one bingo game card located at a plurality of locations remote from the central system and in communication with the central system, comprising the steps of creating at the remote station at least one matrix of numbers to be printed on a game card strip, communicating the at least one matrix of numbers to the central system, recording the at least one matrix of numbers in the central system database, assigning a strip identifier to the game card strip at the central system, communicating the strip identifier to the remote station, printing the game card strip at the remote station, generating a random sequence of bingo numbers at the central system, communicating the sequence of bingo numbers one at a time to the remote stations during play, and communicating the sequence of numbers to participants at the remote locations.

The present invention further provides a system for playing a game of chance over a computer network, the game of chance involving a game card comprising a numerical matrix in which a game operator calls out numbers in random order and a winner is declared when the called out numbers match a designated pattern of numbers on the game card, comprising a central system including a computer comprising a database and host system software for controlling the progress of the game of chance, communications means, and a random number generator for generating numbers in a random sequence, a plurality of remote stations for creating and distributing sheets of card strips each comprising at least one game card, located at a plurality of locations remote from the central system and in communication with the central system, each of the remote stations comprising a random number generator for creating a matrix of numbers for each of said at least one game cards to be printed on a game card strip, the remote stations including means for communicating the matrix of numbers for each game card to the central system for storage in the database, the central system including means for assigning a card strip identifier to each card strip and means for communicating the card strip identifier to the remote station associated with each card strip, and one or more printers in communication with each remote station for printing one or more game card strips.

The present invention further provides a method of playing a game of chance over a computer network, the game of chance involving a game card comprising a numerical matrix in which a game operator calls out numbers in random order and a winner is declared when the called out numbers match a designated pattern of numbers on the game card, utilizing a system comprising a central system including a computer comprising a database and host system software for controlling the progress of the game of chance, communications means, and a random number generator for generating numbers in a random sequence, and a plurality of remote stations for creating and distributing sheets of card strips each comprising at least one game card located at a plurality of locations remote from the central system and in communication with the central system, comprising the steps of creating at the remote station at least one matrix of numbers to be printed on a game card strip, communicating the at least one matrix of numbers to the central system, recording the at least one matrix of numbers in the central system database, assigning a strip identifier to the game card strip at the central system, communicating the strip identifier to the remote station, printing the game card strip at the remote station, generating a random sequence of numbers at the central system, communicating the sequence of numbers one at a time to the remote stations during play, and communicating the sequence of numbers to participants at the remote locations.

### BRIEF DESCRIPTION OF THE DRAWINGS

In drawings which illustrate by way of example only a preferred embodiment of the present invention,

FIG. 1 is a block diagram showing a preferred embodiment of the system of the present invention, and

FIG. 2 is a schematic representation of a sheet of two bingo card strips printed at a remote station.

### DETAILED DESCRIPTION OF THE INVENTION

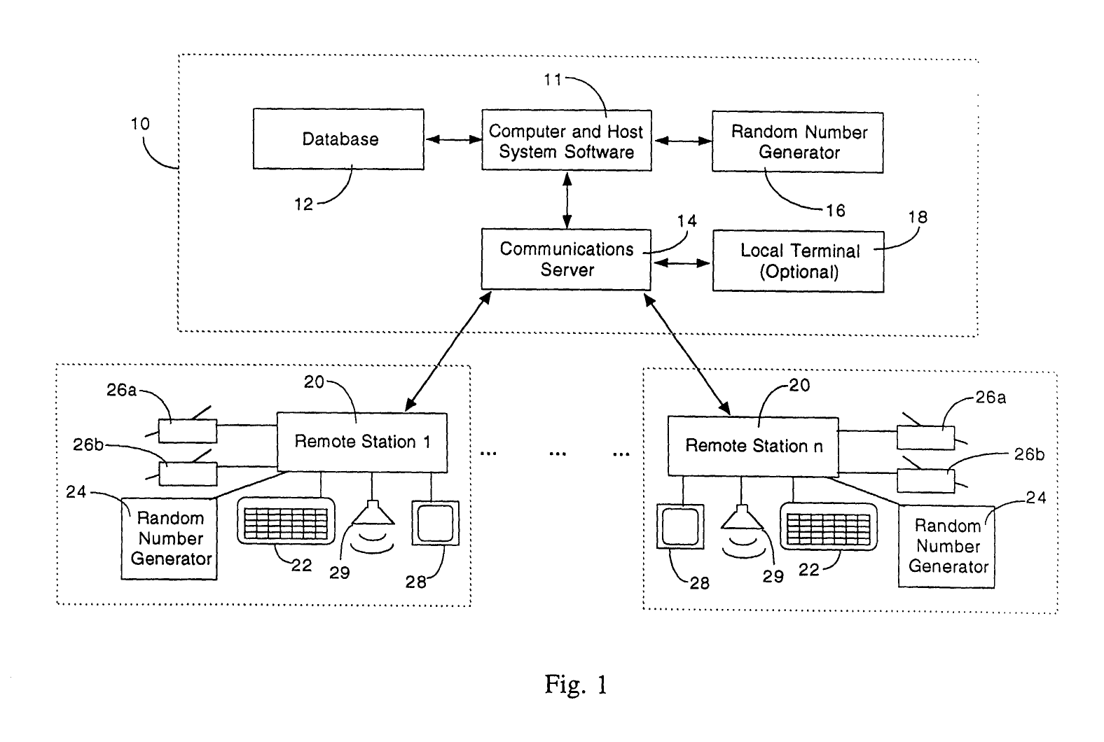

FIG. 1 schematically illustrates a preferred embodiment of the system of the invention. The system will be described in relation to the well known game of chance “bingo”, however it will be appreciated that the system may be equally applied to other like games of chance involving random number generation, with appropriate modifications which will be apparent to those skilled in the art.

A central system 10 is operated by a bingo game operator, preferably (but not necessarily) from a single central location. A plurality of remote stations 20 in communication with the central system 10 are disposed at locations remote from the central system 10.

The central system 10 comprises a computer 11 having a database 12 for storing bingo game card matrices 34, bingo card strip 32 and card identifier information 36 and the numbers generated during a game of bingo. In the preferred embodiment the central system 10 further includes host system software comprising a game controller application, which controls the timing of the game during play, and one or more transaction processors communicating with the plurality of remote stations 20 through communications means such as a communications server 14. The central system 10 may communicate with the remote stations 20 through conventional telephone lines, radio or television communications or satellite transceivers (for example if the remote stations 20 are too widespread geographically to permit direct communications from the central location), or by any other suitable communications means. A local station 18 performing the same functions as the remote stations 20 may optionally be disposed at the central system location, enabling the game of bingo to be played at the central system location.

The central system computer 11 host system software also functions to record information communicated from the remote stations 20; to create and assign identifier information to bingo card strips 30 (and to individual bingo game matrices 34 if the card strips 32 comprise more than a single game card matrix 34); and to communicate with the remote stations 20 in performing these functions. Many computers are suitable for accommodating these functions, for example an Intel-based Pentium (trademark) personal computer (PC). The central system 10 further includes a random number generator 16 which is preferably contained within the central system 10 software, but may alternatively comprise a separate module in communication with the central system computer 11, for generating a random sequence of bingo numbers to be retrieved by the game controller and communicated by the transaction processor(s) to the remote stations 20 while a bingo game is in progress.

Each of the remote stations 20 preferably comprises a conventional PC workstation suitable for supporting the necessary client software, such as an Intel-based Pentium (trademark) PC, and in the preferred embodiment performs the following functions:

i) Creating game card strips 30: Using the remote station keyboard 22, or a mouse or the like (not shown) if the remote station software supports a graphic user interface, the operator at the remote station 20 signals the remote station 20 to print a bingo card strip 30, which may consist of one or more bingo game cards 32 each consisting of a numerical matrix 34 (conventionally a 5×5 matrix) with numbers conventionally ranging from 1 to 75. This may be in direct response to a participant's request for a card strip 30, or card strips 30 may be printed in advance of their purchase in anticipation of the number of participants which will be playing the scheduled bingo game. In the preferred embodiment each remote station 20 comprises a random number generator 24 which creates the numerical matrix for each bingo game card.

In the preferred embodiment each bingo card strip 30 consists of three bingo game cards 32 in which the numbers 1 to 75 all appear exactly once (known as a “perfect board”). However, it will be appreciated that the number of bingo game cards 32 appearing on each card strip 30 is a matter of selection, and the invention is not intended to be limited thereby.

ii) Communicating the bingo game card matrix or matrices 34 to the central system 10: The remote station 20 communicates the bingo game card matrix or matrices for a card strip 30 to the central system 10. As the central system 10 is processing a request for a card strip 30 from a remote station 20, the central system 10 stores the bingo game card matrix or matrices 34 in the database 12 and assigns card numbers 36 to the bingo game cards 32 (if the card strip 30 consists of more than one bingo game card matrix 34) and a strip number to the bingo card strip 30. The central system 10 sends a signal to the remote station 20 acknowledging receipt of the request for a card strip 30.

iii) Receiving strip identifier information: The strip number is encrypted by the central system 10 with other identifying information, preferably including a unique strip number, a game number, a remote station number, and a system identifier (which prevents test strips or card strips from other bingo systems from being treated as valid), to create a strip identifier 38 unique to the bingo card strip 30 generated by the remote station 20. The strip identifier 38 is communicated to the remote station 20, which associates the strip identifier 38 with the game card strip 30.

iv) Verifying communications: In one preferred embodiment the central system 10 communicates the game card matrix or matrices 34 back to the remote station 20 along with the card numbers 36 and the strip identifier 38 assigned to the card strip 30 by the central system 10. The remote station 20 sends a signal to the central system 10 acknowledging receipt of the game card matrix or matrices 34, card numbers 36 and strip identifier 38.

In another preferred embodiment, the remote station 20 stores the game card matrix or matrices 34 generated by the remote station's random number generator, and communicates the matrix information to the central system 10. The central system 10 generates strip identifier 38 and communicates only this information (optionally with card numbers 36) back to the remote station 20. The remote station 20 associates the strip identifier 38 (and card numbers 36, if provided) with the card strip 30 containing the game card matrix or matrices 34 as stored in the remote station 20.

v) Printing the card strip 30: Upon receiving the card numbers 36 and strip identifier 38, the remote station 20 prints the bingo card strip 30 on a printer 26 in communication with the remote station 20. In the preferred embodiment the remote station 20 is in communication with two printers 26a and 26b, the printer 26a being a primary printer and the printer 26b being provided as a backup printer in case the primary printer 26a fails.

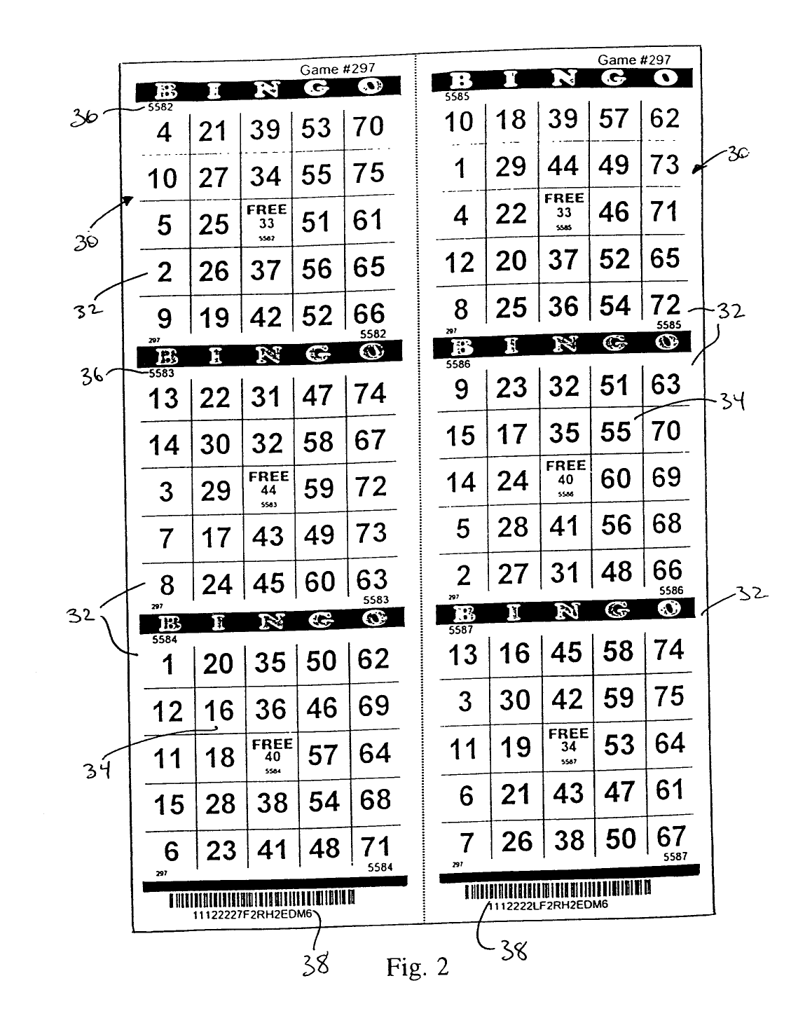

Also, in the preferred embodiment the remote station 20 prints more than one card strip 30 with each request. Preferably the remote station 20 operator can choose between printing a sheet of two card strips 30 (arranged horizontally) or a sheet of four card strips 30 (arranged horizontally), the card strips 30 in each case being separated by a perforated line, as in the two-card card strip 30 shown in FIG. 2.

vi) Conveying to participants the random sequence of numbers generated during a bingo game: The central system 10 comprises, or is in communication with, a random number generator 16 which generates a series of numbers to be “called” during the progress of a bingo game. In the preferred embodiment, prior to the commencement of a game the central system random number generator 16 generates the entire series of 75 numbers in random order and writes the numbers in sequence into the database 12. During the game the central system 10 communicates the numbers one at a time, in sequence, to all remote stations 20. The remote stations 20 in turn communicate each number as it is received from the central system 10, to the participants, preferably visually on monitors 28 distributed about the remote location for viewing by the participants and audibly through a public address system 29 using a voice recording resident in memory in the remote station 20 or a voice synthesizer in communication with (or forming part of) the remote station 20. It is also possible for the sequence of numbers to be made available only to the remote station operator, for example on a monitor disposed at the remote station, in which case the operator communicates the numbers vocally to the participants. However, it is preferred that once play begins the remote station operator's participation be limited to sending a “stop” request to the central system 10 when a win is declared by a participant and communicating the declaring participant's winning card number 36 to the central system 10.

vii) Ending the game: When a participant declares a win by calling out “bingo”, the remote station operator signals the central system 10 that a win has been declared, preferably by depressing a single “stop” key which sends a “stop” signal to the central system 10 immediately following the declaration of a win by a participant. Upon receiving the “stop” signal the game controller suspends play for a predetermined interval, for example 30 seconds, allowing time for the remote station operator to enter the card number 36 into the remote station keyboard 22 and communicate same to the central system 10. The central system 10 matches the numbers already communicated to the remote stations 20 during play against the numbers on the game cards 32 in the card strip 38 identified by the remote station operator, as stored in the central system 10 database, to verify that it is a winning card.

Each bingo game is scheduled to proceed at a specified time at all remote locations. Card strips 30 are requested by the remote station operators (the central system operator may set a time at which the sale of bingo card strips 30 begins), either in advance in anticipation of the number of participants who will be playing at each remote location, or in direct response to participants' requests to purchase bingo card strips 30. Each participant is charged a fee for each bingo card strip 30. The central system operator can elect to allow unsold bingo card strips 30 to be cancelled up to a specified time before the game begins, or may require payment for all bingo card strips 30 requested by a remote station 20 whether or not the card strips 30 are sold to participants. Preferably card strips 30 cannot be purchased during a specified time interval immediately before the game begins, for example 15 minutes, and the host software at the central system 10 is designed to reject requests for card strips 30 made during that interval.

In the preferred embodiment of the invention it is contemplated that each remote station 20 is disposed at a location where multiple participants can play the bingo game, for example at a bingo hall. The remote stations 20 are thus expected to print multiple sheets of card strips 30 before each bingo game, and there can be many remote stations 20. The central system 10 is thus designed to accommodate multiple card strip requests from different remote station locations, and should have the capacity to respond to each card strip request by recording the bingo game card matrix or matrices 34 for each card strip 30, and assigning and and communicating card and strip identifier information expeditiously, so as not to delay the creation of bingo card strips 30 at the various remote locations.

In the operation of the preferred embodiment, prior to commencement of a bingo game the random number generator 16 associated with central system 10 generates bingo numbers from 1 to 75 in a random order and writes them in sequence to the database. The bingo game proceeds at the scheduled time. The game controller, which controls the timing of the game functions, signals the transaction processor(s) to communicate the first number in the sequence in turn to all remote stations 20. Upon receipt of the number each remote station 20 signals the transaction processor(s) that the number has been received, and the number is preferably displayed visually on monitors 28 at each remote location and/or “called out” audibly over a public address system 29 by a voice resident in memory at the remote stations 20 or by speech synthesizers associated with the remote stations 20. Once all remote stations 20 have confirmed receipt of a number, the game controller pauses for a predetermined interval (for example 10 seconds) before signalling the transaction processor(s) to communicate the next number, to ensure that each number is displayed at each remote location for at least the specified time period.

The players mark their bingo cards in conventional fashion. Once the required pattern of numbers, which may typically be a line (row or column), an “X” shape (both diagonals), a cross (center row and center column), four corners, or a complete card, has been marked on a participant's bingo card 32, that participant declares a win by calling out “bingo” at which point the remote station 20 operator at that location signals the central system 10 that a win has been declared by depressing the “stop” key. The central system 10 game controller suspends play for the predetermined interval and signals the remote stations 20 to display a “BINGO CALLED” message at the remote locations while prompting the remote station operator to communicate the card card number 36 for the winning card strip 30.

The central system 10 verifies the win by comparing the sequence of numbers communicated to the remote stations 20 up to the point that the “stop” signal was received with the matrix of numbers 34 on the identified card strip 30, as stored in the central system database 12.

If the central system determines that the card strip 30 associated with the strip identifier 38 communicated by the remote station operator does not contain a winning card, the game continues. An image of the declaring participant's card may be displayed at the remote locations showing the number(s) still required to declare a win. If an incorrect card number is entered an error message may be displayed at the remote locations. If no valid strip number 38 with a winning matrix 34 is entered within the predetermined interval (eg. 30 seconds), a message such as “NO GOOD BINGOS, GAME CONTINUES” may be displayed at the remote locations and the game controller signals the transaction processor(s) to communicate the next number from the central system database 12 sequence.

If a “stop” signal is received from more than one remote station 20, the remote station operator at each such remote station 20 is prompted to enter the card number 36 of the card strip 30 containing a winning matrix 34. The game controller allows the full interval for each remote station operator to enter the strip identifier 38, for example 30 seconds from the time that the “stop” key was depressed at each individual remote station 20. If more than one card strip contains a winning matrix 34, a tie is declared and the prize may be divided accordingly.

In the preferred embodiment, in which only a single bingo game is scheduled for any designated time period, once the win is verified the main game is over and the main prize is awarded to the winning participant. However, the game may continue at all other remote locations, so that there can be a winner at each remote location who will collect a secondary prize. In this embodiment the central system 10 communicates the remaining ball numbers as a batch to each remote station 20 at the “non-winning” remote locations so that the game can continue. The game is played locally at each remote location during this part of the game, without regard to the speed or continuity of play at the other remote locations. The central system 10 remains in communication with the remote stations 20 to verify a win when declared by a participant at each remote station 20.

In a further embodiment, in which multiple bingo games are played at the scheduled time, once a win is verified the game is over at all remote locations and the designated prize is awarded to the winning player. The central system 10 is then reset for another game, allowing a preset time interval for the purchase of further card strips 30 by the participants at the remote locations, and the game proceeds as described above.

Preferred embodiments of the invention having been described by way of example only, it will be appreciated that certain modifications and adaptations may be made to the system and method of the invention without departing from the scope of invention, as set out in the appended claims.

The embodiments of the invention in which an ezclusive property or privilege is claimed are defined as follows:

1. A system for playing bingo over a computer network, comprising
a central system including a computer comprising a database and host system software for controlling the progress of a game of bingo, communications means, and a random number generator for generating bingo numbers in a random sequence,
a plurality of remote stations for creating and distributing sheets of bingo card strips each comprising at least one bingo game card, located at a plurality of locations remote from the central system and in communication with the central system,
each of the remote stations comprising a random number generator for creating a matrix of numbers for each of said at least one bingo game cards to be printed on a game card strip,
the remote stations including means for communicating the matrix of numbers for each game card to the central system for storage in the database,
the central system including means for assigning a card strip identifier to each card strip and means for communicating the card strip identifier to the remote station associated with each card strip, and
one or more printers in communication with each remote station for printing one or more game card strips.

2. The system of claim 1 in which one or more of the remote stations include means for communicating to participants the numbers randomly generated at the central location.

3. The system of claim 1 in which each remote station creates card strips upon request by an operator at the remote station.

4. The system of claim 1 in which the central system further includes means for signalling an acknowledgement to the remote station that a matrix of numbers has been received by the central system.

5. The system of claim 1 in which the numbers generated by the central system random number generator are written to the database in the sequence generated prior to the commencement of a bingo game.

6. The system of claim 2 in which the numbers generated by the central system random number generator are displayed on monitors simultaneously at each of the remote locations.

7. The system of claim 1 in which the remote station includes means for communicating a stop signal to the central system when a participant at the remote location associated with said remote station declares a winning card strip.

8. The system of claim 1 in which the central system includes means for matching the numbers communicated to the remote stations during play against the numbers on the identified game card to verify the winning card strip.

9. A method of playing bingo over a computer network comprising a central system including a computer comprising a database and host system software for controlling the progress of a game of bingo, communications means, and a random number generator for generating bingo numbers in a random sequence, and a plurality of remote stations for creating and distributing sheets of bingo card strips each comprising at least one bingo game card located at a plurality of locations remote from the central system and in communication with the central system, comprising the steps of
creating at the remote station at least one matrix of numbers to be printed on a game card strip,
communicating the at least one matrix of numbers to the central system,
recording the at least one matrix of numbers in the central system database,
assigning a strip identifier to the game card strip at the central system,
communicating the strip identifier to the remote station,
printing the game card strip at the remote station,
generating a random sequence of bingo numbers at the central system,
communicating the sequence of bingo numbers one at a time to the remote stations during play, and
communicating the sequence of numbers to participants at the remote locations.

10. The method of claim 9 in which the central system communicates the at least one matrix of numbers to the remote station along with the strip identifier.

11. The method of claim 9 in which the remote station stores the at least one matrix of numbers and associates therewith the strip identifier communicated from the central system before printing the game card strip.

12. The method of claim 9 in which the remote stations generate one or more game card strips upon request by an operator at the remote station.

13. The system of claim 9 in which the central system signals an acknowledgement to the remote station that a matrix of numbers has been received by the central system.

14. The system of claim 9 in which the remote station signals an acknowledgement to the central system that a strip identifier has been received by the remote station.

15. The method of claim 9 in which the random sequence of numbers generated by the central system is written in sequence to the database prior to the commencement of a bingo game.

16. The method of claim 9 in which the numbers generated by the central system random number generator are displayed on monitors at each of the remote locations.

17. The method of claim 16 including the step of sending a stop signal to the central system when a participant at a remote station declares a win.

18. The method of claim 27 including the step of communicating the strip identifier of the declared winning card strip to the central system for matching the numbers generated during play against the numbers on the declared winning card strip to verify the declared winning card strip.

19. A system for playing a game of chance over a computer network, the game of chance involving a game card comprising a numerical matrix in which a game operator calls out numbers in random order and a winner is declared when the called out numbers match a designated pattern of numbers on the game card, comprising
a central system including a computer comprising a database and host system software for controlling the progress of the game of chance, communications means, and a random number generator for generating numbers in a random sequence,
a plurality of remote stations for creating and distributing sheets of card strips each comprising at least one game card, located at a plurality of locations remote from the central system and in communication with the central system,
each of the remote stations comprising a random number generator for creating a matrix of numbers for each of said at least one game cards to be printed on a game card strip,
the remote stations including means for communicating the matrix of numbers for each game card to the central system for storage in the database,
the central system including means for assigning a card strip identifier to each card strip and means for communicating the card strip identifier to the remote station associated with each card strip, and
one or more printers in communication with each remote station for printing one or more game card strips.

20. A method of playing a game of chance over a computer network, the game of chance involving a game card comprising a numerical matrix in which a game operator calls out numbers in random order and a winner is declared when the called out numbers match a designated pattern of numbers on the game card, utilizing a system comprising a central system including a computer comprising a database and host system software for controlling the progress of the game of chance, communications means, and a random number generator for generating numbers in a random sequence, and a plurality of remote stations for creating and distributing sheets of card strips each comprising at least one game card located at a plurality of locations remote from the central system and in communication with the central system, comprising the steps of
creating at the remote station at least one matrix of numbers to be printed on a game card strip,
communicating the at least one matrix of numbers to the central system,
recording the at least one matrix of numbers in the central system database,
assigning a strip identifier to the game card strip at the central system,
communicating the strip identifier to the remote station,
printing the game card strip at the remote station,
generating a random sequence of numbers at the central system,
communicating the sequence of numbers one at a time to the remote stations during play, and
communicating the sequence of numbers to participants at the remote locations.
